(19) United States
(12) Patent Application Publication
(10) Pub. No.: US 2015/0370186 A1
(43) Pub. Date: Dec. 24, 2015

(54) Toner Formulations for Controlling Wax Dispersion and Domain Size

(71) Applicant: Lexmark International, Inc., Lexington, KY (US)

(72) Inventors: Yueping Fu, Longmont, CO (US); Lance Tisdale Hoshiko, Longmont, CO (US); James Craig Minor, Niwot, CO (US); Courtney Ann Weigel, Longmont, CO (US); Franklin Dilworth Zartman, Loveland, CO (US)

(73) Assignee: Lexmark International, Inc., Lexington, KY (US)

(21) Appl. No.: 14/249,600

(22) Filed: Apr. 10, 2014

Related U.S. Application Data
(60) Provisional application No. 61/811,198, filed on Apr. 12, 2013.

(51) Int. Cl. G03G 9/083; G03G 9/087

(52) U.S. Cl. CPC G03G 9/0833; G03G 9/08755

(57) ABSTRACT

Wax dispersion and domain size can be effectively controlled by incorporating a small amount of a hybrid resin binder and or a wax compatibilizer in the toner formulation. Such toners show smaller wax domain size and improved fusing offset window, fusegrade and filming resistance, and therefore improved print quality and reliability. The hybrid resin contains a polyester unit via condensation reaction and a vinyl-based polymer unit via radical polymerization. The hybrid resin is highly compatible with the polyester resin binder, and at same time, can well accommodate low molecular weight polyolefin waxes in the vinyl polymer entity enabling a desirable smaller wax domain size. The wax compatibilizer is a thermoplastic styrenic block copolymer.

### CROSS REFERENCES TO RELATED APPLICATIONS

This patent application is the utility application of U.S. Provisional Patent Application 61/811,198, filed Apr. 12, 2013, entitled “Toner Formulations for Controlling Wax Dispersion and Domain Size.”

### BACKGROUND

1. Field of Disclosure

This invention generally relates to wax release agent dispersion and wax domain size in toner, toner particulates and toner compositions used in electrophotographic printers, both conventional toners and those formulated for magnetic ink character recognition (“MICR”) applications. This invention also relates to methods to improve dry fuser release and fusegrade on transferred media and print quality for high speed printing.

2. Description of the Related Art

Styrene acrylic copolymers have long been the resin binder of choice for toner formulations in mechanically milled or chemically prepared toners. However, there has been a desire to replace styrene acrylic resins with polyester resin in toner formulations because the substitution of the polyester resin for the styrene acrylic resin results in a toner having improved fusing performance and print quality. However, toner formulations made with various polyester binders showed poor reliability and print quality due to severe streaking and filming after the printing only a few hundred pages. Further investigation by the inventors found that the wax domain size in polyester toner formulations is not well controlled and was too large due to the inherent incompatibility of the polyester resin and the wax used as the release agent. This invention provides a unique toner formulation to be used in mechanically milled toners. The unique toner formulation allows the necessary wax content for fuser release with good control of the wax domains in the toner. This toner of the present invention is especially useful in all toner applications including single component, dual component and magnetic ink character recognition (MICR). The toner may be utilized in an electrophotographic printer such as a printer copier, multi-function device or an all-in-one device.

Numerous methods and apparatuses for electrophotography, electrostatic recording and electrostatic printing are known in the art. Typically, a charged photosensitive surface, for example a charged photosensitive drum, is irradiated with an optical image and an electrostatic latent image is formed on the photosensitive surface. In the development process, a developing agent, i.e., toner is adhered to the electrostatic latent image.

Typically, a thin, uniformly charged toner layer is placed on the developer roller by a metering blade positioned against the surface of the developer roller. The developer roller, with the toner on its surface, is typically rotated in a direction opposite to that of the photosensitive drum, and electrically charged toner adheres to the electrostatic latent image to develop the image. Various toner compositions have been developed in order to provide improved copying, recording and/or printing with such apparatus.

One method of fusing a toner image to a substrate is to bring the toner in contact with a hot surface such as a heated roll or belt. However, there is a tendency for a fuser to collect small amounts of toner which in turn causes toner offset to build up on the fuser surface. This toner may be then transferred to a subsequent substrate, thereby causing a poor image. In severe cases, the toner may adhere to the fuser and cause the paper to stick or wrap to the fuser roll or belt.

The fuser roll surface may be wetted with a release agent such as silicone oil in order to decrease the problem of toner offset. Unfortunately, the silicone oil release agent may leave oil residues on the paper, thereby interfering with the image quality. Additionally, the release agent material may deteriorate over time with continuous exposure to high temperature. Therefore, a dry or oil-less fuser, that is a fuser without any oil on its surface, is often desirable.

It is desirable that toner compositions readily release from dry fuser rollers or belts, exhibit good fuse grade and provide prints having good print quality.

In order to solve the problem of toner offset with dry fusers, release agents such as lubricants or waxes are added to the toner. Although large amounts of wax in toners, such as more than about 3% by weight, improves fuser release, such large amounts of wax often have deleterious effects on overall print quality. Many conventional waxes tend to separate from the toner during the process of toner manufacturing (particularly at the pulverizing step) and/or toner development at printing.

Generally, incorporating large amounts of wax in toner formulations result in toners having undesirable, bigger wax domains, ultimately resulting in poor print quality results. The free wax can deposit on any warm surface, such as the doctor blade, causing filming problems which adversely affect print quality.

Toner release performance after fusing is critical to image quality and permanence. Fusing offset window is a measure of the temperature range within which toner can successfully release from the fusing system and fuse onto the substrate. At higher temperatures, hot offset can cause fuser contamination and poor print quality. At lower temperatures, cold offset can cause poor adhesion of toner to the substrate and cause poor print quality. Fusegrade is a measure of the degree of toner adhesion to the substrate. Both the fusing offset window and fusegrade are highly dependent on the amount of wax on the toner surface in a fusing system where temperature, pressure and residence time are specified.

Wax content and dispersibility in toner play an important role in toner release performance. One measure of wax dispersion is wax physical domain size in toner. Wax domain size is determined by examining the fracture surface of a cryogenically fractured toner sample with scanning electron microscopy. The largest wax domain diameters are recorded.

Low molecular weight polyolefin waxes are widely used in toners. Such waxes have orders of magnitude lower melt viscosity compared to resin binder. In the melt mixing process, waxes melt and are dispersed within the resin binder matrix, forming separate wax domains. The sharp melting characteristics of polyesters relative to styrene-acrylate resins make the dispersion of the wax more difficult. A more fundamental reason for poor wax dispersion is due to the inherent thermodynamic incompatibility between the wax and the resin binder. The Flory-Huggins interaction parameter between the resin and wax is usually positive (repulsive) and large so that the interfacial energy remains very large in favor of phase separation into large domains to reduce interfacial area. The incompatibility between polyolefin waxes and polyester resin binder is more prominent because of significant differences in polarity. Fractures within the toner as it is milled tend to occur at the weakest parts of the matrix which includes the interfaces between the incompatible wax domains and resin. Large wax domains tend to expose upon fracture than small wax domains. Surface wax can cause toner to stick together and exhibit poor ship/store performance.

Some success in wax dispersion improvement has been achieved. One method is to add wax compatibilizer to the toner to reduce the wax domain size. The other is to add functionalized enhancing agent to improve dry fuser release. Another, low temperature and high shear mixing can effectively reduce wax domain size. At low temperatures, viscosity of the melt is higher and thus mixing is improved however, improved mixing is difficult to achieve because of the sharper melting characteristics of polyester resins.

### SUMMARY

The inventors have discovered that wax dispersion and domain size can be effectively controlled by incorporating a small amount of a hybrid resin binder and or a wax compatibilizer in the toner formulation. Such toners show smaller wax domain size and improved fusing offset window, fusegrade and filming resistance, and therefore improved print quality and reliability. The hybrid resin contains a polyester unit via condensation reaction and a vinyl-based polymer unit via radical polymerization. The hybrid resin is highly compatible with the polyester resin binder, and at same time, can well accommodate low molecular weight polyolefin waxes in the vinyl polymer entity enabling a desirable smaller wax domain size. The wax compatibilizer is a thermoplastic styrenic block copolymer.

### DESCRIPTION

It is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the terms “a” and “an” herein do not denote a limitation of quantity, but rather denote the presence of at least one of the referenced item.

The hybrid resin is a resin in which a vinyl-based polymer unit and a polyester unit are chemically bonded to each other. Specifically, the hybrid resin component is a resin formed by ester exchange between a polyester unit and a vinyl-based polymer unit. Functional monomers which can carry both radical polymerization and condensation reaction are employed in the hybrid resin. Examples of functional monomers containing both vinyl and carboxylate groups are (meth)acrylic acids and maleic anhydride. Examples of functional monomers containing both vinyl and hydroxyl group are 2-hydroxyethyl(meth)acrylates, 2-hydroxypropyl(meth)acrylates, 4-(1-hydroxyl-1-methylbutyl)styrene, and 4-(1-hydroxyl-1-methylhexyl)styrene.

Examples of vinyl-based monomers which can improve wax dispersion are aromatic vinyl monomers, such as styrene and its derivatives, where R1 to R6 can be hydrogen or alkyl group containing 1-20 carbons.

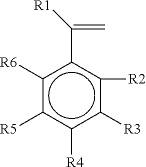

Other vinyl monomers which can be incorporated in free radical copolymerization are: olefins, such as ethylene, propylene, butylenes, butadiene and isoprene; α-methylene aliphatic monocarboxylates where R1 and R2 can be hydrogen or alkyl group containing 1-20 carbons.

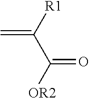

STPL-1 and STPL-15 are examples of the hybrid resin described above. They are manufactured by Kao Corporation. The total hybrid resin may be provided in the range of about 3% to about 40% by weight of the final toner formulation including all values and increments.

The inventors have also discovered that the addition of a particular type of thermoplastic styrenic block copolymer can be added to the toner formulation of the present invention to further improve wax dispersion, therefore enable high wax content in toner. The styrenic block copolymer acts as a compatibilizer. The block copolymer, compatible with the hybrid resin via styrene unit, and polyolefin wax via ethylene and/or propylene unit. The styrenic block copolymers are of the structure A-(block)-B or A-b-B-b-A with the polymeric segments A and B each being defined below. In embodiments of the present invention, the styrenic block copolymer is of the formula A-b-B or A-b-B-b-A wherein A-b-B is a block copolymer having 2 segments A and B. A-b-B-b-A is a block copolymer having 3 segments A, B and A. Most importantly, the segment A is compatible or identical to the toner resin that is used in the toner formulation of the present invention and the segment B is compatible or identical to the wax used in the toner formulation of the present invention. The molecular weight of the polymeric segment A is between 3,000 to 100,000 and the molecular weight of the polymeric segment B is between 10,000 to 200,000. The styrenic block copolymer may be provided in the range of about 0.5% to about 10.0% by weight of the final toner formulation including all values and increments. Examples of styrenic block copolymers include styrene-ethylene/propylene (SEP), styrene-ethylene/butylene-styrene (SEBS), styrene-ethylene/propylene-styrene (SEPS), and styrene and butadiene. In one useful block copolymer, the A segment is the styrene block and the B segment is the ethylene/propylene block.

It is believed that the styrenic block copolymer used in the toner formulation functions as an intermediate to bring together the wax and the polyester resin binder more closely in the toner. Exemplary styrenic block copolymers are the Kraton® G Series, manufactured by Kraton® Performance Polymers, Inc.

The polyester resin component incorporated into the toner formulation of the present invention herein may therefore be understood as including those polyesters which have an acid value of about 5 to about 50, including all values and increments therein. Such acid value may be due to the presence of one or a plurality of free carboxylic acid functionalities (—COOH) in the polyester. For example, acid values of about 10-40, or about 20-30, etc. An acid value is reference to the mass of potassium hydroxide (KOH) in milligrams that is required to neutralize one gram of the polyester. The acid value is therefore a measure of the amount of carboxylic acid groups in the polyester. Reference to an acid value as having a value of about 5 to about 50 may also be understood as reference to an acid value that may vary by about +/−0.50 individual acid value units.

The polyester herein may also be characterized as those polyesters that have a glass transition temperature (Tg) as measured by differential scanning calorimetry (DSC), wherein the onset of the shift in baseline (heat capacity) thereby indicates that the Tg may occur at about 40-80° C. at a heating rate of about 5° C. per minute (e.g. 4.75° C. per minute to 5.25° C. per minute). The midpoint value of the Tg may therefore occur at a slightly higher temperature, at about 43-83° C., including all values and increments therein. Reference to a Tg value of, e.g., about 40 to about 80° C. (onset) may also be understood to include all values and increments therein as well as a variation in the observed individual Tg value of +/−1.5° C.

The polyesters herein may include those polyesters that have a peak MW (Mp) as determined by gel permeation chromatography (GPC) of about 2,500 to about 40,000 as well as all values and increments therein. For example, the value of Mp may be about 4,000-25,000, at +/−500 units. In addition, the polyesters suitable for use herein may be characterized by their molecular weight distribution (MWD) value, or weight average molecular weight (Mw) divided by the number average molecular weight (Mn). Accordingly, the polyesters herein may have a MWD of about 2 to about 30, including all values and increments therein, wherein a given MWD value may be understood to vary +/−0.50. Accordingly, the MWD may have a value of about 3 to about 25, or 4 to about 20 etc.

The polyesters herein may therefore include those which may be characterized as having one or all of the characteristics noted above, and therefore may include linear and/or branched aliphatic and/or aromatic polyesters having the following general formulas:

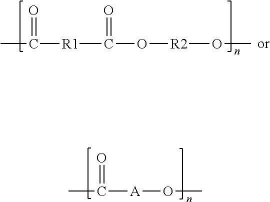

wherein R1 and/or R2 and A may be an aliphatic, aliphatic-aromatic or wholly aromatic group and n may have a value the provides a Mp value of about 2,500-40,000 as noted above. In addition, R1 and/or R2 and A may include a branch, which branching may be selected so as to provide a desired Tg value. By way of further example, the polyester herein may be formed from monomers such as terephthalic anhydride, trimellictic anhydride, 2-dodecen-1 yl-succinic anhydride, ethoxylated or propoxylated bisphenol A which may then provide the following random copolymer structural units in the polyester chain:

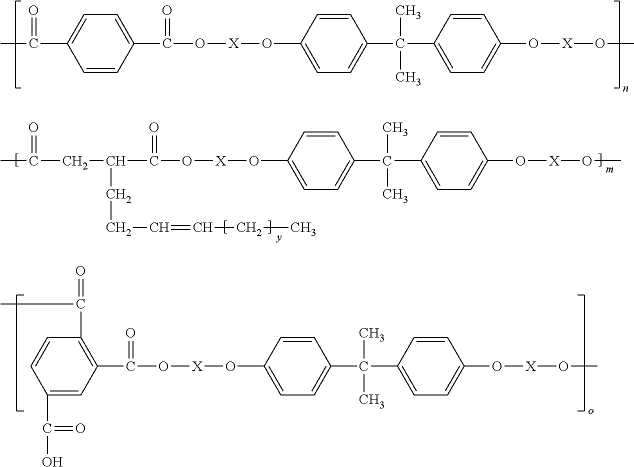

wherein n, m and o are integers which may again provide a Mp value of about 2,500 to 40,000, X is an aliphatic moiety which may then provide groups such as an ethyl (—CH₂CH₂—) or propyl (—CH₂—CH₂—CH₂—) group, and y may be an integer having a value of 1-20 including all values and increments therein. For example, y may have a value of 8 which would be the result of forming the above polyester from 2-dodeceny-1-yl succinic anhydride in the presence of terephthalic anhydride, trimellitic anhydride and ethoxylated or propoxylated bisphenol A. In addition, as noted above, it may be appreciated that the indicated aliphatic branch may contain residual unsaturation.

Example polyester resins include but are not limited to T100, TF-104, NE-1582, NE-701, NE-2141N, NE-1569, W-85N, NE2158N, Binder C, TPESL-10, TPESL-11, FPESL-2 and TL-17, available from Kao Corporation, Tokyo, Japan or mixtures thereof. The total polyester resin may be provided in the range of about 40% to about 95% by weight of the final toner formulation including all values and increments therebetween.

The toner formulation may include a colorant. Colorants are compositions that impart color or other visual effects to the toner and may include carbon black, dyes (which may be soluble in a given medium and capable of precipitation), pigments (which may be insoluble in a given medium) or a combination of the two. Alternatively, a self-dispersing colorant may be used. The colorant may be present at less than or equal to about 15% by weight of the final toner formulation including all values and increments therebetween.

The toner formulation includes a release agent. The release agent may include any compound that facilitates the release of toner from a component in an electrophotographic printer (e.g. release from a roller surface). For example, the release agent may include polyolefin wax, ester wax, polyester wax, polyethylene wax, metal salt of fatty acids, fatty acid esters, partially saponified fatty acid esters, higher fatty acid esters, higher alcohols, paraffin wax, carnuba wax, amide waxes and polyhydric alcohol esters.

The release agent may therefore include a low molecular weight hydrocarbon based polymer (e.g., Mn≦10,000) having a melting point of less than about 140° C. including all values and increments between about 50° C. and about 140° C. For example, the release agent may have a melting point of about 60° C. to about 135° C., or from about 65° C. to about 100° C., etc. The release agent may be provided in the range of about 2% to about 20% by weight of the final toner formulation including all values and increments therebetween.

Examples release agents include hydrocarbon waxes (e.g. polyethylenes such as Polywax™ 400, 500, 600, 655, 725, 850, 1000, 2000 and 3000 from Baker Petrolite and polypropylenes; paraffin waxes and waxes made from CO and H₂, especially Fischer-Tropsch waxes such as Paraflint™ C80 and H1 from Sasol); ester waxes (M-754 from Chukyo Yushi Company), including natural waxes such as Carnuba and Montan waxes; amide waxes; and mixtures of these. Functional waxes, i.e. having functional groups, may also be used (e.g. acid functional waxes, such as those made using acidic monomers, e.g. ethylene/acrylic acid co-polymer, or grafter waxes having acid groups grafted onto the wax).

The toner formulation may optionally comprise a charge control agent (CCA). Suitable charge control agents are preferably colorless. Preferably, they include metal complexes, more preferably aluminum or zinc complexes, phenolic resins etc. Examples include Bontron™ E84, E-84-S, E88, E89 and F21 from Orient; Kayacharge N1, N3 and N4 from Nippon Kayaku; LR147 from Japan Carlit; TN-105 from Hodogaya. The CCA may be provided in the range of about 0.5% to about 10% by weight of the final toner formulation including all values and increments.

Another optional ingredient that can be used in toner is silica. The silica may be provided in the range of about 0.5% to about 5% by weight of the toner formulation including all values and increments. Also iron oxide can be added to the toner formulation. If the iron oxide is incorporated into the toner formulation, it may be provided in the range of about 1% to 60% by weight of the toner formulation including all values and increments.

The components (resin or a plurality of resins, wax and any additional ingredients listed in the tables below) for a test toner, A-L, are weighted to the specified amounts and added to a batch mixer (Henschel FM-40) where they are blended for a brief period of time. The blended resin mixture is next added to a twin-screw extruder (Werner Pfleiderer ZSK-30) where it is melt mixed at a temperature 100° C. to about 200° C. to a homogenous state followed by cooling and crushing. The crushed extrudate is next ground in a fluid bed jet mill (Alpine AFG-100) and classified (Matsubo Elbow-Jet air classifier) to the desired particle size, 6 μm-10 μm, preferably 7 μm-9 μm. Any desired extra particulate additives (e.g. silicas and titanias) are blended on the toner with a high speed blender (VRIECO-NAUTA Cyclomix).

The toner formulations were prepared using the materials listed in the tables below describing Toner formulations A-L. All amounts shown in the tables are in weight percent based on the total weight of the toner compositions, unless otherwise specified.

Exemplary polyester resins and their respective properties used for the toner formulation of the present invention are listed below.

### Properties of Polyester Resins

| | Tg (° C.) | | | Acid |
|---|---|---|---|---|
| Resin | (onset/midpoint) | Mp | MWD | Value |
| Polyester Resin 1 | 60/64 | 8000 | 4 | 31 |
| Polyester Resin 2 | 60/63 | 5000 | 2 | 17 |
| Polyester Resin 3 | 58/61 | 12000 | 5.3 | 32 |
| Polyester Resin 4 | 61/64 | 13000 | 14 | 23 |

### Properties of Hybrid Resins

| | Tg (° C.) | | | Acid |
|---|---|---|---|---|
| Resin | (onset/midpoint) | Mp | MWD | Value |
| Hybrid Resin 1 | 58/62 | 12000 | 13.5 | 26 |
| Hybrid Resin 2 | 57/60 | 11200 | 6.7 | 28 |

Toner Formulations A-L

| A (control) | | B | | C | | D | |
|---|---|---|---|---|---|---|---|
| | wt % | | wt % | | wt % | | wt % |
| Polyester Resin | 48.6 | Polyester Resin | 40.5 | Polyester Resin | 48.6 | Polyester Resin | 40.5 |
| 1 | | 1 | | 1 | | 1 | |
| Polyester Resin | 32.4 | Polyester Resin | 32.4 | Polyester Resin | 32.4 | Polyester Resin | 32.4 |
| 2 | | 2 | | 3 | | 3 | |
| | | Hybrid Resin 1 | 8.1 | | | Hybrid Resin 1 | 8.1 |
| Iron Oxide | 9 | Iron Oxide | 9 | Iron Oxide | 9 | Iron Oxide | 9 |
| Carbon Black | 6 | Carbon Black | 6 | Carbon Black | 6 | Carbon Black | 6 |
| Silica | 1 | Silica | 1 | Silica | 1 | Silica | 1 |
| PE Wax¹ | 1 | PE Wax¹ | 1 | PE Wax¹ | 1 | PE Wax¹ | 1 |
| Ester Wax² | 1.5 | Ester Wax² | 1.5 | Ester Wax² | 1.5 | Ester Wax² | 1.5 |
| CCA³ | 0.5 | CCA³ | 0.5 | CCA³ | 0.5 | CCA³ | 0.5 |
| E | | F | | G | | H | |
| | wt % | | wt % | | wt % | | wt % |
| Polyester Resin | 33.3 | Polyester Resin | 33.3 | Polyester Resin | 33 | Polyester Resin | 33 |
| 4 | | 4 | | 4 | | 4 | |
| Polyester Resin | 22.2 | | | Polyester Resin | 22 | | |
| 3 | | | | 3 | | | |
| | | Hybrid Resin 2 | 22.2 | | | Hybrid Resin 2 | 22 |
| Iron Oxide | 40 | Iron Oxide | 40 | Iron Oxide | 40 | Iron Oxide | 40 |
| PE Wax¹ | 2 | PE Wax¹ | 2 | PE Wax¹ | 1 | PE Wax¹ | 1 |
| Ester Wax² | none | Ester Wax² | none | Ester Wax² | 1.5 | Ester Wax² | 1.5 |
| CCA³ | 2.5 | CCA³ | 2.5 | CCA³ | 2.5 | CCA³ | 2.5 |
| I | | J | | K | | L | |
| | wt % | | wt % | | wt % | | wt % |
| Polyester Resin | 32.7 | Polyester Resin | 32.7 | Polyester Resin | 33.3 | Polyester Resin | 33.3 |
| 4 | | 4 | | 4 | | 4 | |
| Polyester Resin | 21.8 | | | | | | |
| 3 | | | | | | | |
| | | Hybrid Resin 2 | 21.8 | Hybrid Resin 1 | 22.2 | Hybrid Resin 2 | 22.2 |
| (SEP) Styrenic | 1 | (SEP) Styrenic | 1 | (SEP) Styrenic | 1 | (SEP) Styrenic | 1 |
| Block | | Block | | Block | | Block | |
| Copolymer | | Copolymer | | Copolymer | | Copolymer | |
| Iron Oxide | 40 | Iron Oxide | 40 | Iron Oxide | 40 | Iron Oxide | 40 |
| PE Wax¹ | 2 | PE Wax¹ | 2 | PE Wax¹ | 2 | PE Wax¹ | 2 |
| Ester Wax² | none | Ester Wax² | none | Ester Wax² | none | Ester Wax² | none |
| CCA³ | 2.5 | CCA³ | 2.5 | CCA³ | 1.5 | CCA³ | 1.5 |

¹PE Wax is Polywax 655 from Baker Petrolite.
²Ester Wax is M-754 from Chukyo Yushi Company.
³CCA is a Change Control Additive Bontron E-84-S from Orient Chemical.
⁴ SEP is styrene-ethylene/propylene.

Wax Domain Diameters (μm)

| Toner | μm |
|---|---|
| A | 3.9 |
| B | 2.1 |
| C | 3.5 |
| D | 2.4 |
| E | 4.4 |
| F | 3.5 |
| G | 4 |
| H | 2.8 |
| I | 2.9 |
| J | 1.6 |
| K | 1.5 |
| L | 1.4 |

It can be seen that wax domain size is decreased in toners having the hybrid resin in its formulation. Wax domain sizes are further decreased with the addition of both the hybrid resin and the styrenic block copolymer.

Another test performed on certain toners was a fuse grade evaluation. Fuse grade evaluation is accomplished by printing a line pattern or solid black on a specified paper type at a specified temperature. The fused image is rubbed with a white cloth for a specified number of times under a controlled load and speed. A suitable instrument is a Crockmeter from Taber Industries. The optical density of the cloth is measured after it is rubbed on the fused page. A higher optical density on the cloth occurs when more toner is removed from the test page. Higher fusing temperatures result in better fused images and subsequently, less toner is removed from the test page and a lower optical density is measured on the rubbing cloth. Toners can be compared to one another by fusing printed test images at equivalent temperatures and evaluating them using the described fusing test. Again, toners that transfer less to the rubbing cloth (and measure lower optical density) are those that are better fusing.

Toner A and Toner B were the same formulation except Toner B had a 10% addition of the hybrid resin. Toner B had a better fuse grade test result compared to control Toner A. Toner formulations C and D also show the same trend. Toner D also had a better fuse grade than Tone C, wherein Toner D also incorporated 10% of the hybrid resin into its formulation.

1. A toner composition comprising:
a resin binder including a polyester or a plurality of polyesters,
a colorant, selected from the group consisting of carbon black dyes, pigments, self-dispersant colorant and iron oxide,
a wax compatibilizer including a thermoplastic block copolymer,
a hybrid resin formed from the chemically bonding of a vinyl-based polymer unit and a polyester unit: and
a release agent selected from the group consisting of polyolefin wax, ester wax, polyester wax, polyethylene wax, metal salt of fatty acids, fatty acid esters, partially saponified fatty acid esters, higher fatty acid esters, higher alcohols, paraffin wax, carnuba wax, amide waxes and polyhydric alcohol esters,
wherein the thermoplastic block copolymer functions as an intermediate to bring together the release agent and the resin binder closer in the toner composition to reduce the wax domain size and improve print quality.

2. The toner composition of claim 1, wherein the colorant is iron oxide.

3. The toner composition of claim 1 further comprising a charge control agent.

4. The toner of claim 1 further comprising a silica.

5. The toner composition of claim 1, wherein the thermoplastic block copolymer is a thermoplastic styrenic block copolymer and has the formula A-b-B or A-b-B-b-A and A-b-B is a block copolymer having two segments A and B and A-b-B-b-A is a block copolymer having three segments A, B, and A.

6. The toner composition of claim 5, wherein the segment A is compatible with the resin binder used in the toner formulation and the segment B is compatible with the release agent used in the toner formulation.

7. The toner composition of claim 1, wherein the hybrid resin is formed by ester exchange between the polyester unit and the vinyl-based polymer unit.

8. The toner composition of claim 1, wherein the release agent is a hydrocarbon wax, an ester wax or a combination of an ester wax and a hydrocarbon wax.

9. The toner composition of claim 5, wherein the thermoplastic styrenic block copolymer is present in the amount of about 0.5% to about 10.0% by weight of the final toner formulation including all values and increments.

10. The toner composition of claim 1, wherein the hybrid resin is present in the amount of 3% to about 40.0% by weight of the final toner formulation including all values and increments.

11. The toner composition of claim 1, wherein the polyester resin binder has an acid value of about 10 to about 40.

12. The toner composition of claim 1, wherein the polyester resin binder indicates the onset of a glass transition temperature (Tg) at a heating rate of about 5° C./minute in a differential scanning calorimeter of about 40° C. to about 80° C.

13. The toner composition of claim 1, wherein the polyester resin binder has a peak MW as determined by gel permeation chromatography (Mp) of about 2,500 to about 40,000 and a molecular weight distribution of about 2 to about 30.

14. A toner composition for use in magnetic ink character recognition applications comprising:
a resin binder including a polyester or plurality of polyesters,
a colorant including an iron oxide,
a wax compatibilizer including a thermoplastic block copolymer,
a hybrid resin formed from the chemically bonding of a vinyl-based polymer unit and a polyester unit: and
a release agent selected from the group consisting of polyolefin wax, ester wax, polyester wax, polyethylene wax, metal salt of fatty acids, fatty acid esters, partially saponified fatty acid esters, higher fatty acid esters, higher alcohols, paraffin wax, carnuba wax, amide waxes and polyhydric alcohol esters,
wherein the thermoplastic block copolymer functions as an intermediate to bring together the release agent and the resin binder closer in the toner composition to reduce the wax domain size and improve print quality.

15. The toner composition of claim 14 further comprising a charge control agent.

16. The toner composition of claim 1, further comprising a silica.

17. The toner composition of claim 14, wherein the thermoplastic block copolymer is a thermoplastic styrenic block copolymer and has the formula A-b-B or A-b-B-b-a and A-b-B is a block copolymer having two segments A and B and A-b-B-A is a block copolymer having three segments A, B, and A.

18. The toner composition of claim 17, wherein the segment A is compatible with the resin binder used in the toner formulation and the segment B is compatible with the release agent used in the toner formulation.

19. The toner composition of claim 14, wherein the hybrid resin is formed by ester exchange between the polyester unit and the vinyl-based polymer unit.
